(19) United States
(12) Patent Application Publication
(10) Pub. No.: US 2016/0027122 A1
(43) Pub. Date: Jan. 28, 2016

(54) METHOD FOR ADJUSTING A PREMIUM

(71) Applicant: Erlan H. Feria, Princeton, NJ (US)

(72) Inventor: Erlan H. Feria, Princeton, NJ (US)

(21) Appl. No.: 14/875,064

(22) Filed: Oct. 5, 2015

Related U.S. Application Data
(63) Continuation-in-part of application No. 14/243,149, filed on Apr. 2, 2014.
Application No. 14/243,149 is a continuation-in-part of application No. 13/646,224, filed on Oct. 5, 2012.
(60) Provisional application No. 62/059,273, filed on Oct. 3, 2014.
(60) Provisional application No. 61/807,363, filed on Apr. 2, 2013.
(60) Provisional application No. 61/544,838, filed on Oct. 7, 2011.

(51) Int. Cl. G06Q 40/08

(52) U.S. Cl. CPC G06Q 40/08

(57) ABSTRACT

The subject matter disclosed pertains to a computer-implemented method for determining a life insurance premium or setting a wage rate. The premium or wage rate is based on a theoretical adult lifespan (τ_{theroy}_{_{—}}_{adult}) calculation that arises from universal linger thermodynamic theory.

### CROSS-REFERENCE TO RELATED APPLICATIONS

This application claims priority to and the benefit of U.S. provisional patent application 62/059,273 (filed Oct. 3, 2014) and is a continuation-in-part of U.S. patent application Ser. No. 14/243,149 (filed Apr. 2, 2014) which claims priority to U.S. non-provisional patent application 61/807,363 (filed Apr. 2, 2013). U.S. patent application Ser. No. 14/243,149 is also a continuation-in-part of U.S. application Ser. No. 13/646,224 (filed Oct. 5, 2012) which claims priority to and the benefit of U.S. provisional patent application 61/544,838 (filed Oct. 7, 2011). All of the above-mentioned patent applications are incorporated herein by reference in their entirety.

### BACKGROUND OF THE INVENTION

Life insurance premiums are calculated based on a variety of parameters including the individual's demographic data and their medical history including their weight. Traditionally, insurance companies utilize actuarial tables and other calculations in an attempt to predict the individual's life expectancy. This predicted life expectancy, in turn, impacts the individual's life insurance premium. Those individuals with a short life expectancy pay high premiums while those with relatively long life expectancy pay lower premiums.

Unfortunately, the actuarial tables used by insurance companies only correlate some variables which are currently believed to impact life expectancy. Additional medical studies have discovered new variables that the current tables fail to consider. It would be desirable to provide an improved method for calculating life insurance premiums that takes into account additional variables so as to provide more accurate life expectancy predictions.

The discussion above is merely provided for general background information and is not intended to be used as an aid in determining the scope of the claimed subject matter.

### BRIEF DESCRIPTION OF THE INVENTION

The subject matter disclosed pertains to a computer-implemented method for determining a life insurance premium. The premium is based on a theoretical adult lifespan (τ_{theory}_{_{—}}_{adult}) calculated according to universal linger thermodynamic theory.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a graph of the mathematical relationship between specific heat and the resulting impact on adult lifespan;

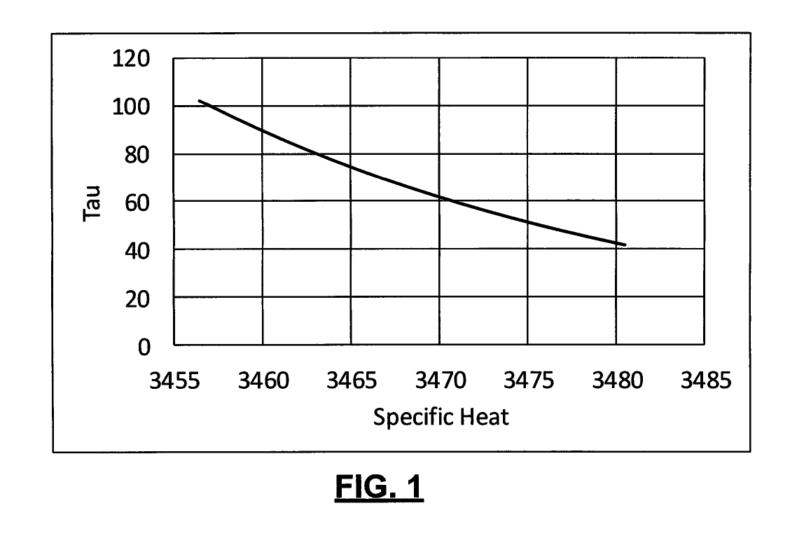

FIG. 2 is a graph of the mathematical relationship between body mass and nutritional consumption rate and the resulting impact on adult lifespan;

FIG. 3 is a flow diagram of an exemplary method for calculating a life insurance premium; and

FIG. 4 is an exemplary computer system for executing the operations of an application program for carrying out the calculation of life expectancy in accordance with this disclosure.

### DETAILED DESCRIPTION OF THE INVENTION

The subject matter disclosed herein relates to the calculation of an adult lifespan and the use of this lifespan in determining a life insurance premium. Traditional calculations and actuarial tables often presume that individuals with a high weight are unhealthy. These calculations and tables impose high life insurance premiums on these individuals. These high premiums are not always warranted. In a recent study, researchers were surprised to discover that low-weight rhesus monkeys had the same life expectancy as higher weight monkeys (Kolata, Severe Diet doesn't Prolong Life, at Least in Monkeys, The New York Times, Aug. 29, 2012).

In another embodiment, the life expectancy calculations described herein consider the specific heat capacity (Cᵥ) ofan individual. Without wishing to be bound to any particular theory, the specific heat capacity (Cᵥ) provides a quantitative measure of the stresses experienced by the individual person's body. For example, if two individuals have equal mass (e.g. both 70 kg) the individual with the higher specific heat capacity (Cᵥ) (while maintaining their weight) is experiencing more metabolic strain. This results in reduced life expectancy despite the controlled weight.

In one embodiment, the life expectancy calculations described herein consider the ratio of the individual's mass to their nutritional consumption rate. High mass individuals who have an appropriately high nutritional consumption rate are therefore not penalized due to their mass. Likewise, low mass individuals do not receive unduly favorable premiums. As shown by the rhesus monkey studies, these individuals are not more likely to have a longer life expectancy simply due to their lower mass. Without wishing to be bound to any particular theory, the ratio of the mass to the nutritional consumption rate provides a quantitative measure of the stresses experienced by the individual person's body. For example, if two individuals have equal mass (e.g. both 70 kg) the individual who consumes more energy (while maintaining weight) is experiencing more metabolic strain. This results in reduced life expectancy despite the controlled weight.

### Specific Heat Embodiment

In one embodiment, the premium is based on a theoretical adult lifespan (τ_{theory}_{_{—}}_{adult}) calculated according to:

$${τ}_{theory} = Δ τ \cdot 3.515 \times {10}^{31} {( 4.872 \times {10}^{- 38} \cdot {C}_{v}^{specific} )}^{0.00048042 ( {c}_{v}^{specific} - 1794 )} \qquad Equation 1$$

where

ΔT is a conversion factor for converting the product to years (e.g. 1 year/365 days) cᵥ^{specific} is a specific heat capacity for the human individual. As used in this specification, the term “about” means within 5%.

To find the specific heat capacity cᵥ^{specific} a mass of food (ΔM) in kg units is given to an individual and then his or her change in temperature (ΔT) is measured from beginning to end of process. ΔM=Q/(5000 kcal/kg times 4.18 joules/cal) where Q is the heat energy consumption rate. The specific heat cᵥ is the ‘dimensionless’ DoF heat capacity of the individual whose value can be multiplied by 1,197 J/kg·K to get the ‘specific’ heat capacity (cfe) in J/kg K units.

For example,

$${C}_{v} = \frac{{DH}_{STORE} ( Heat Stored in Body )}{BODY MASS \times ( {T}_{Initial} - {T}_{Final ( after a few minutes )} )}$$

where DHSTORE=DHMETABOLIC−(DH_{RADIATION}+DH_{CONVECTION}+DH_{EVAPORATION}); DH_{RADIATION}=0.5×A×(T_{SKIN}-T_{OBJ}); DH_{EVAPORATION}(J/min)=2430(J/g)×V_{sweat}^{Q}(g/min); DH_{CONVECTION}=0.5×(T_{SHELL}-T_{AIR}) in kJ/min and A is area, V_{sweat}^{Q} is volume. Also see Chapter 21 in Textbook in Medical Physiology and Pathophysiology, 2nd edition, Poul-Erik Paulev MD, Dr.Med.Sci; published by Copenhagen Medical Publishers 1999-2000.

The above equation was derived using a linger-thermo model for a human as show below. Although this equation assumes a 100 kg individual, computer simulations with 50 kg and 70 kg individuals revealed that this mass-independent equation yields the same lifespan results according to:

$$S = kJ ln ( \frac{{e}^{{c}_{v}} {e}^{n} q ( η )}{{J}^{η}} = \frac{τ}{Δ τ} = … ) \qquad equation 2$$

where η is a degree of freedom coupling constant that is within 0.79 to 0.82; J is the number of thermote particles (e.g. about 7.24×10³⁸); q(n) is the coupling molecular partition factor (e.g. about 1.088×10³⁴); k is the Boltzmann constant; and S is the Boltzmann entropy. The average dimensionless heat capacity cᵥ for a 100 kg individual (with an adult lifespan of 62 years) is about 2.901 while the specific heap capacity cᵥ^{Specific} is about 3470 J/kg·K.

Given equation 2 it follows that:

$$\frac{τ}{Δ τ} = \frac{{e}^{{c}_{v}} {e}^{n} q ( η )}{{J}^{η}} \qquad equation 3$$

Given the relationship between cᵥ and cᵥ^{Specific} using the heat capacity of liquid water at 310 K (the major component of the human body):

$$\frac{{c}_{v}}{7 / 2} = \frac{{c}_{v}^{specific}}{4186 J \text{/} kgK} \qquad equation 4$$

Further given the relationship between J and cᵥ:

J=Mc²/kTcᵥ=(mc²/kTcᵥ)(M/m) equation 5

where c is the speed of light, m is the mass of a molecular of water in kg, T is temperature in kelvin and k is the Boltzmann constant. In further view of linger-thermo theory (where go is about 1, I is the average vibrational frequency of water molecule (about 2×10⁴⁷ kg·m²) ν is the average vibrational frequency of water molecule (about 1.5×10⁹ Hz) and a is the symmetry number of water molecules (about 2)) then q(η) is as follows:

$$q ( η ) = {q}^{e} {{q}^{t} ( {q}^{r} {q}^{v} )}^{\frac{{c}_{V} - 3 / 2}{2}} \approx {{g}_{0} ( \frac{mkT}{2 π {ℏ}^{2}} {V}^{2 / 3} )}^{3 / 2} {( \frac{2 I kT}{σ {ℏ}^{2}} \frac{kT}{2 π ℏ υ} )}^{\frac{{c}_{V} - 3 / 2}{2}} = {{g}_{0} ( \frac{mkT}{2 π {ℏ}^{2}} {( \frac{M}{1000} )}^{2 / 3} )}^{3 / 2} {( \frac{2 I kT}{σ {ℏ}^{2}} \frac{kT}{2 π ℏ υ} )}^{\frac{{c}_{V} - 3 / 2}{2}} \qquad equation 6$$

The coupling factor between water molecules is then given by:

$$η = α ( M ) \frac{{c}_{V} - {c}_{V , Min}}{{c}_{V , Max} - {c}_{V , Min}} = α ( M ) \frac{{C}_{V} - {C}_{V , Min}}{{C}_{V , Max} - {C}_{V , Min}} = α ( M ) \frac{{C}_{V} - 1794 J \text{/} kgK}{3609.9 J \text{/} kgK - 1794 J \text{/} kgK} \qquad equation 7$$

where α(M) is 0.8724346 for M=100 kg.

Advantageously, the specific heat capacity embodiment only uses the specific heat capacity of the individual and there is no need to obtain the mass of the individual.

Exemplary values for α(M) and c_{v,Max} are show below:

| | M = 50 kg | M = 70 kg | M = 100 kg |
|---|---|---|---|
| α (M) | 0.8715213 | 0.8719574 | 0.8724346 |
| c_{v,Max} | 3.018 | 3.018 | 3.018 |

### Nutritional Consumption Rate Embodiment

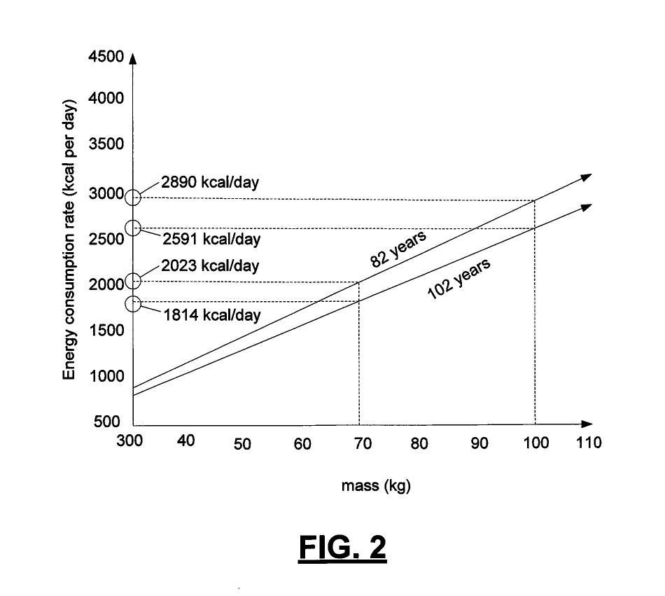

FIG. 2 is a graph showing a mathematical relationship between nutritional consumption rate (ΔM) and mass (M) of a person according to the following equation:

$${τ}_{theory\_adult} = Δ {τ ( \frac{M}{Δ M} )}^{2} \qquad equation 8$$

An upper line shows 82 years of a theoretical adult lifespan (τ_{theory}_{_{—}}_{adult}) while a lower line shows 102 years of a theoretical adult lifespan. An individual person who weighs 70 kg intercepts the 102-year-line when approximately 1814 kcal per day are consumed. Another individual with the same 70 kg mass is predicted to have a theoretical adult lifespan of 82 years if 2023 kcal per day are consumed. In a similar fashion, an individual person who weighs 100 kg is predicted to have a theoretical adult lifespan of 102 years when 2591 kcal per day are consumed but a 82 year theoretical adult lifespan when 2890 kcal per day are consumed. The mathematical model disclosed herein accounts for the fact that a 100 kg individual consuming 2591 kcal per day can have a longer adult lifespan than a 70 kg individual eating 2023 kcal per day. Such information is useful in determining a premium for life insurance.

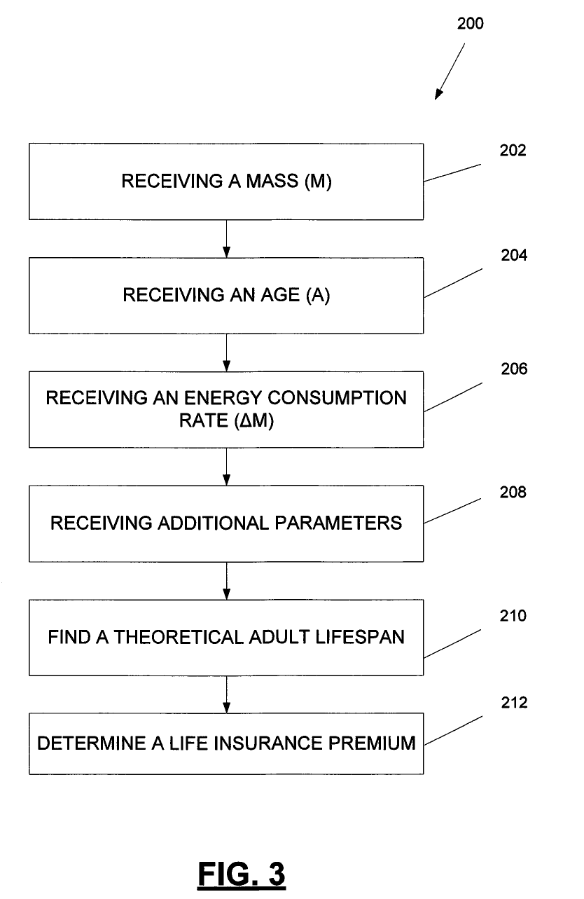

FIG. 3 is a flow diagram of method 200 for determining a life insurance premium for an adult. Method 200 begins with step 202 wherein a mass (M) for an individual person is received and inputted into a computer. For example, an insurance company may receive the mass of an individual person directly from the individual or from a proxy who relays this information to the insurance company. Examples of proxies include insurance agents, medical practitioner including doctors, and the like. Likewise, in step 204, an age of the individual person is received and inputted into the computer.

In step 206 of method 200, a nutritional consumption rate (ΔM) is received and inputted into the computer. The nutritional consumption rate is a quantitative measurement of the consumption of nutrients over a given period of time. For example, mass of food consumed per day (e.g. kg per day) is one manner for expressing nutritional consumption rate. In another embodiment, the nutritional consumption rate is expressed in terms of energy per day (e.g. kcal per day). These two expressions can be inter-converted using a conversion factor (Y). For example, if one assumes that one kg of food supplies, on the average, 5000 kcal of energy, then one can convert a nutritional consumption rate of kcal per day into units of kg per day using a Y value of 5000 kcal per kg. The 5000 kcal per kg is merely one example. Other values of Y may also be used.

An exemplary calculating using a 2000 kcal per day diet is shown below:

$$Δ M = \frac{X kcal}{day} \frac{kg}{Y kcal} = \frac{2000 kcal}{day} \frac{kg}{5000 kcal} = \frac{0.4 kg}{day} \qquad equation 9$$

In step 208, one or more additional demographic parameters concerning the individual person are received and inputted into the computer. Examples of additional demographic parameters include height, age, waist circumference, hip circumference, gender, country of residency, diet, physique, exercise history, drug use (including tobacco and alcohol), personality disposition, level of education, ethnicity, medical history, family medical history, marital status, fitness, economic class, generalized body mass index (GBMI), body volume index (BVI), waist-to-hip-ratio (WHR), environmental/climate/geographic effects, sleep schedule, regularity of visits to healthcare providers and a quantified life-expectancy condition. The life-expectancy condition may be determined, for example, by actuarial tables. In one embodiment, a life-expectancy condition is a number greater than zero and equal to or less than one, with a value of one denoting an ideal condition. GBMI may be calculated by M/h^{c} where M is the individual's mass, h is their height, and c is a value that is set according to the demographics of the individual. C is often assigned values of 2, 2.3, 2.7 or 3 depending on the demographic.

In step 210, a theoretical adult lifespan (ι_{theory}_{_{—}}_{adult) is found according to:}

$${τ}_{theory\_adult} = Δ {τ ( \frac{M}{Δ M} )}^{2} \qquad equation 10$$

The theoretical adult lifespan shown above accounts for both the individual's mass (M) as well as the nutritional consumption rate (ΔM) over a period of time (Δτ). For example, a mass of 70 kg may be received for a given individual person. This same individual consumes 2000 kcal per day which corresponds to 0.4 kg per day as shown below (assuming one kg of food provides an average of 5000 kcal):

$$\frac{2000 kcal}{day} \frac{kg}{5000 kcal} = \frac{0.4 kg}{day} \qquad equation 11$$

Given these inputs, the hypothetical individual person would have a theoretical adult lifespan of 84 years, (1 day=1/365 years) as show below:

$${τ}_{theory\_adult} = Δ {τ ( \frac{M}{Δ M} )}^{2} = \frac{1 year}{365 days} {( \frac{70 kg}{0.4 kg per day} )}^{2} = 84 years \qquad equation 12$$

The theoretical adult lifespan is one of the factors in determining a life insurance premium. In step 212 of method 200, a life insurance premium is determined based, at least in part, on the theoretical adult lifespan. The theoretical adult lifespan refers to the after end-of-growth lifespan and does not include adolescent/childhood lifespan (τ_{childhood}).

In one embodiment of step 212, a value is set for the childhood lifespan (τ_{childhood}). This value is set to include both the childhood and adolescent years during which time the individual is still growing. In one embodiment, the childhood lifespan is set to a value of eighteen years. Depending on demographic and other variables, other values may be set for the childhood lifespan.

A theoretical total lifespan (F) is determined according to:

Γ=τ_{theory}_{_{—}}_{adult}+τ_{childhood} equation 13

In some embodiments, the theoretical total lifespan is used to determine a life insurance premium. The theoretical total lifespan comprises the theoretical adult lifespan.

The theoretical adult lifespan and the theoretical total lifespan are both theoretical lifespans. An expected lifespan (F) is determined. In some embodiments, the expected lifespan is used to determine a life insurance premium.

F=p_{A}(Γ−A) equation 14

The expected lifespan (F) is determined by subtracting the individual person's current age (A) from the theoretical total lifespan (Γ) and then adjusting for the probability of survival (p_{A}) from the age (A) to the theoretical total lifespan (Γ). The probability of survival (p_{A}) may be determined from actuarial tables that take other parameters into consideration. These parameters may be received, for example, in step 208 of method 200.

The maximum total lifespan (Γₘₐₓ) of human beings is not known with certainty but estimations of this value are often made. A maximum adult lifespan (τₘₐₓ) is set according to:

τₘₐₓ=Γₘₐₓ−τ_{childhood} equation 15

For example, some individuals believe the maximum total lifespan (Γₘₐₓ) is one-hundred twenty years. If one sets the childhood lifespan (ι_{childhood}) to eighteen years, then the maximum adult lifespan (τₘₐₓ) would be set to be equal to one-hundred two years. This value is one factor that is useful in determining the probability of survival (p_{A}) which is one of the factors in determining the expected lifespan (F). The expected lifespan (F), in turn, is used to determine a life insurance premium.

In one embodiment, the probability of survival (p_{A}) is calculated according to the equation shown below, where P(x) is a positive number that is a function of the demographic parameter vector x where the value of P(x) is appropriately determined using actuarial tables.

$${p}_{A} = \frac{{τ}_{Max} + P ( x ) ( {τ}_{theory\_adult} - {τ}_{Max} )}{{τ}_{Max}} \qquad equation 16$$

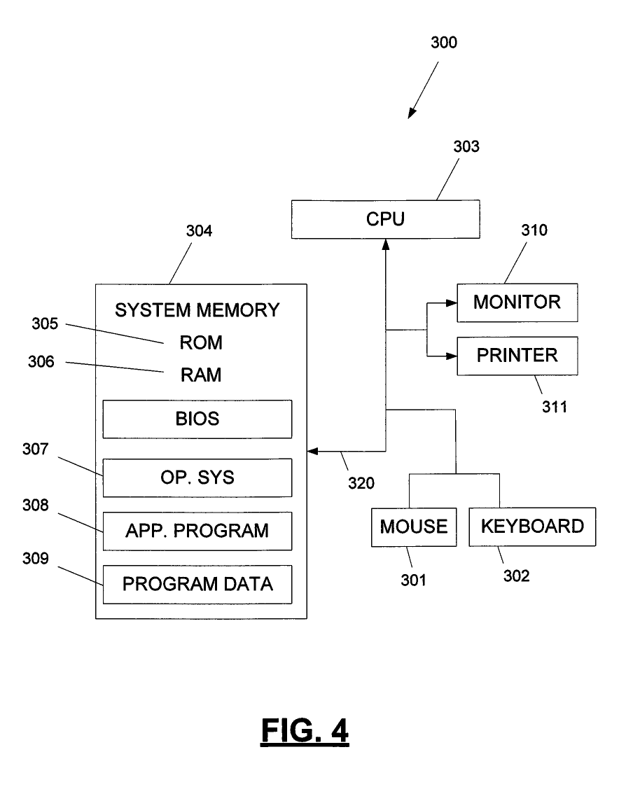

Turning to FIG. 4, there is shown a typical computer system 300 for executing the operations of an application program 308 for carrying out the calculation of life expectancy in accordance with this patent. The computer system 300 has an input apparatus such as a mouse 301 and a keyboard 302 for inputting data and commands to the system 300. System memory 304 includes read only memory (ROM) 305 and random access memory (RAM) 306. RAM 306 holds the BIOS program that allows the system to boot and become operative. RAM 306 holds the operating system 307, the life expectancy application program 308 and the program data 309 in memory 304. Those skilled in the art understand the RAM may be part of the internal memory of the system 300 or may be stored on one or more external memories (e.g. thumb drives, flash RAMs, floppy or external hard disks, not shown) or may be portions of a large internal RAM. A bus 320 carries data and instructions to from system memory 304 to a central processing unit 303. The bus also carries input data user commands form the input mouse 301 and keyboard 302 to the CPU 303 and the system memory 304. Bus 320 also connects the system memory, CPU and input apparatus to output peripherals such as a monitor 310 and a printer 311. In operation, the life expectancy program 308 carries computer readable code to instruct the CPU to carry out the calculation of life expectancy as described above and display the result on the monitor or the printer.

### Calculation of the Nutritional Consumption Rate (ΔM)

In some embodiments, the nutritional consumption rate (ΔM) is not provided by the individual or a proxy and must be received in another manner. In one embodiment, the nutritional consumption rate (ΔM) is received as the result of a calculation.

### Determination of the Nutritional Consumption Rate (ΔM) by GBMI

In one embodiment, the nutritional consumption rate (ΔM) is calculated based on the individual person's GBMI (τ_{indiv}) as a function of an appropriately selected optimum GBMI (βₒₚₜ). The value of β_{indiv} is determined using the mass (M) and height (h) of the individual person according to:

$${β}_{indiv} = \frac{M}{{h}^{c}} \qquad equation 17$$

An optimum GBMI (βₒₚₜ) is established based on, for example, ethnicity, geographic region (e.g. United States, Japan, etc.) or based on the muscularity/body frame. For example, for the United States, a GBMI (βₒₚₜ) may be set to 25. By way of further example, for Japan, a GBMI (βₒₚₜ) may be set to 23. In one embodiment, the nutritional consumption rate (ΔM) is calculated from the GBMI (βₒₚₜ) according to:

$$Δ M = \frac{{β}_{opt} + k ( x ) \vert {β}_{indiv} - {β}_{opt} \vert}{{β}_{opt}} \sqrt{\frac{Δ τ}{{τ}_{max}}} M \qquad equation 18$$

where k(x) is a positive number that is a function of the demographic parameter vector x with the value of k(x) determined using actuarial tables.

In another embodiment, the body volume index (BVI) is used instead of the body mass index.

### Determination of the Nutritional Consumption Rate (ΔM) by WHR

In one embodiment, the nutritional consumption rate (ΔM) is calculated based on the individual person's waist-to-hip ratio (WHR, γ_{indiv}) as a function of an appropriately selected optimum WHR, (γₒₚₜ). The value of τ_{indiv} is determined using the waist measurement (w) and hip (H) of the individual person according to:

$${γ}_{indiv} = \frac{w}{H} \qquad equation 19$$

An optimum WHR (γₒₚₜ) is established based on, for example, ethnicity, geographic region (e.g. United States, Japan, etc.) or other demographic information. For example, for the United States, a WHR (γₒₚₜ) may be set to 0.7 for females and 0.9 for males. By way of further example, for Japan, a WHR (γₒₚₜ) may be set to 0.6 for females and 0.8 for males. In one embodiment, the nutritional consumption rate (ΔM) is calculated from the WHR (γₒₚₜ) according to:

$$Δ M = \frac{{γ}_{opt} + b ( x ) \vert {γ}_{indiv} - {γ}_{opt} \vert}{{γ}_{opt}} \sqrt{\frac{Δ τ}{{τ}_{max}}} M \qquad equation 20$$

where b(x) is a positive number that is a function of the demographic parameter vector x with the value of b(x) determined using actuarial tables.

The methods of determining the nutritional consumption rate (ΔM) described above are only examples. Other suitable methods of determining a nutritional consumption rate (ΔM) would be apparent to those skilled in the art after benefitting from reading this specification. In certain embodiments, a given value of ΔM may be received that leads to clearly erroneous results. For example, a ΔM may be received that results in a theoretical adult lifespan (τ_{theory}_{_{—}}_{adult}) that is greater than the maximum adult lifespan (τ_{Max}). Similarly, a ΔM may be calculated which may result in a theoretical adult lifespan (τ_{theory}_{_{—}}_{adult}) that is greater than the maximum adult lifespan (τ_{Max}). The method may further comprise the step of verifying the integrity of the calculations by checking against a threshold value (e.g. the maximum adult lifespan (τ_{Max})) and taking corrective action. Examples of corrective action include notifying the user of the error and/or requesting a corrected value of ΔM be supplied.

In view of the foregoing, embodiments of the invention include the ratio of the individual's mass to the individual's nutritional consumption rate when predicting individual lifespan. A technical effect is to permit more accurately predictions for the lifespan of an individual.

### Time Compression

Since an adult individual of age (A) over eighteen years experiences each day of his life to be shorter than when he first became an adult at age eighteen, the adult presently views X days of life expectancy to be shorter than when the adult viewed these same X days as an eighteen year old. The actual amount of this time compression has been found using a linger-thermo model for a human. More specifically, this time compression factor (CF_{A}) is given by:

$${CF}_{A} = \frac{{τ}_{childhood} + Δ {τ ( \frac{{M}_{A}}{Δ {M}_{A}} )}^{2} - A}{Δ {τ ( \frac{{M}_{childhood}}{Δ {M}_{childhood}} )}^{2}} \qquad equation 21$$

In the equations above, Δτ is a conversion factor (e.g. 1 year=365 days), M_{A} is the mass of the individual as an adult, M_{childhood} is the mass of the individual at the end of childhood (e.g. τ_{childhood}=18 years, ΔM_{A} is the nutritional consumption rate, ΔM_{childhood} is a nutritional consumption rate for a new adult (e.g. eighteen year old). In one embodiment, ΔM_{childhood} is determined by solving the equation below for an individual of a given mass.

$$Δ {M}_{childhood} = \frac{{M}_{childhood}}{\sqrt{\frac{{Γ}_{max} - {τ}_{childhood}}{Δτ}}} \qquad equation 22$$

Thus at least two relevant applications of the time compression factor can be identified. They are: 1) on the setting of a life insurance premium by an insurance company; 2) on the setting of a wage rate by an employer. It should be appreciated that the childhood lifespan (τ_{childhood}) is often set to be 18 years, as is traditional in U.S. culture. In other cultures, other values of τ_{childhood} may be used.

In setting a life insurance premium an insurance company should reflect the time compression experienced by a person older than eighteen years such that the premium is reduced by a reasonable amount. To determine this appropriate amount the theoretical adult time compression equation 21 can be used. For example, if the currently paid premium for X days is

P_{Current}(X)=$100 equation 23

by an adult individual of age A, this premium could be reduced in price as follows:

P_{New}(X)=ƒ(CF_{A})×P_{Current}(X)=J(CF_{A})×$100=$95 equation 24

where J(CF_{A}) is some function of CF_{A} selected by the insurance company, e.g., it could be the linear function

J(CF_{A})=k×CF_{A}<1 equation 25

where k is some appropriately determined constant value. This constant may be determined, for example, by actuarial tables.

On the other hand, in setting a wage rate an employer should reflect the time compression experienced by a person older than eighteen years such that his wage is increased by a reasonable amount. To determine this appropriate amount the theoretical adult time compression equation 21 can be used. For example, if the currently paid wage for X days is

W_{current}(X)=$1,000 equation 26

by an adult individual of age A, this wage could be increased in price as follows:

W_{New}(X)=W_{current}(X)/ƒ(CF_{A})=$1,000/J(CF_{A})=$1,050 equation 27

where J(CF_{A}) is some function of CF_{A} selected by the employer, e.g., it could be the linear function

ƒ(CF_{A})=k×CF_{A}<1 equation 28

where k is some appropriately determined constant value. This constant may be determined, for example, by an age based productivity table (e.g. an actuarial table).

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable non-transitory signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied in the form of an application program on a computer readable medium may be transmitted using any appropriate medium, including but not limited to wireless, wireline, optical fiber cable, RF, etc., or any suitable combination of the foregoing. An application program 308 holding the instructions for the subject life expectancy calculation program is stored in RAM 306.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example 1

### Nutritional Consumption Rate

A system for determining a life insurance premium is established that sets the childhood lifespan (τ_{childhood}) to eighteen years, the maximum total lifespan (Γₘₐₓ) to 120 years. The parameters of an individual person are received as follows: M=70 kg; age (A)=40 years; ΔM=0.4 kg per day (based on 2000 kcal per day at 5000 kcal per kg); life-expectancy condition=1 (ideal), height=1.6 m; waist circumference 70 cm; hip circumference 100 cm, gender=female; country=US; diet=1 (excellent); ethnicity=1 (Hispanic); fitness=1 (excellent); economic class=1 (middle class); BVI=0 (denoting data not available); value of c in GBMI calculation=2. When the aforementioned parameters are received, steps 202, 204 and 206 have been performed. The individual's theoretical adult lifespan is then determined as follows:

$$\begin{matrix}{τ}_{theory\_adult} = {Δτ ( \frac{M}{Δ M} )}^{2} \\ = \frac{1 year}{365 days} {( \frac{70 kg}{0.4 kg per day} )}^{2} \\ = 84 years\end{matrix} \qquad equation 29$$

Using the set value of eighteen for the childhood lifespan (τ_{childhood}), a theoretical total lifespan (Γ) is determined according to:

Γ=τ_{theory}_{_{—}}_{adult}+τ_{childhood}=84 years+18 years=102 years equation 30

Actuarial tables are consulted and a suitable probability of survival (p_{A}) is chosen based on the individual person's demographic data. In the hypothetical example 1, p_{A} is 0.95 and the current age (A) is 40 years. An expected lifespan (F) is determined as follows:

F=p_{A}(Γ−A)=0.95(102 years−40 years)=59 years equation 31

### Example 2

### Nutritional Consumption Rate

A system for determining a life insurance premium is established that is substantially identical to example 1 except in that the ΔM is determined to be 0.52 kg per day (based on 2600 kcal per day at 5000 kcal per kg). The individual's theoretical adult lifespan is then determined as follows:

$$\begin{matrix}{τ}_{theory\_adult} = {Δτ ( \frac{M}{Δ M} )}^{2} \\ = \frac{1 years}{365 days} {( \frac{70 kg}{0.52 kg per day} )}^{2} \\ = 50 years\end{matrix} \qquad equation 32$$

Using the set value of eighteen for the childhood lifespan (τ_{childhood}), theoretical total lifespan (Γ) is determined:

Γ=τ_{theory}_{_{—}}_{adult}+τ_{childhood}=50 years+18 years=68 years equation 33

Actuarial tables are consulted and a suitable probability of survival (p_{A}) is chosen based on the individual person's demographic data. In the hypothetical example 1, p_{A} is 0.95 and the current age (A) is 40 years. An expected lifespan (F) is determined as follows:

F=p_{A}(Γ−A)=0.95(68 years−40 years)=27 years equation 34

By contrasting examples 1 and 2 it is apparent the individual in example 2 has a reduced expected lifespan (F) as a result of the increased consumption. It is important to recognize this reduced expected lifespan (F) is not the result of obesity (the example presumes a constant mass of 70 kg for both individuals) but is believed to be the result of metabolic strain experienced by burning more calories per day in order to maintain the 70 kg weight.

### Example 3

### Nutritional Consumption Rate

A system for determining a life insurance premium is established that is substantially identical to example 2 except in that the mass (M) of the individual is 91 kg. The nutritional consumption rate remains 0.52 kg per day (based on 2600 kcal per day at 5000 kcal per kg). The individual's theoretical adult lifespan is then determined as follows:

$$\begin{matrix}{τ}_{theory\_adult} = {Δτ ( \frac{M}{Δ M} )}^{2} \\ = \frac{1 year}{365 days} {( \frac{91 kg}{0.52 kg per day} )}^{2} \\ = 84 years\end{matrix} \qquad equation 35$$

Using the set value of eighteen for the childhood lifespan (τ_{childhood}), a theoretical total lifespan (Γ) is determined:

Γ=τ_{theory}_{_{—}}_{adult}+τ_{childhood}=84 years+18 years=102 years equation 36

Actuarial tables are consulted and a suitable probability of survival (p_{A}) is chosen based on the individual person's demographic data. In the hypothetical example 1, p_{A} is 0.95 and the current age (A) is 40 years. An expected lifespan (F) is determined as follows:

F=p_{A}(Γ−A)=0.95(102 years−40 years)=59 years equation 37

By contrasting examples 1 and 3 it is apparent both individuals have the same expected lifespan (F) despite the individual of example 3 being heavier and consuming more energy.

### Example 4

### Nutritional Consumption Rate

A system for determining a life insurance premium is established that is substantially identical to example 1 except in that the ΔM for the individual person is not known or is not provided. The ΔM is calculated based on the GBMI of the individual. An individual GBMI (β_{indiv}) is calculated using the mass (M) and height (h) of the individual person as follows:

$${β}_{indiv} = \frac{M}{{h}^{c}} = \frac{70}{{1.6}^{2}} = 27.3437 \qquad equation 38$$

Based on demographic information, an optimum GBMI (βₒₚₜ) is set at 25. A value of 0.947 is set for k(x) based on the demographic profile of the individual. The value of ΔM is then calculated as shown below:

$$\begin{matrix} Δ M = \frac{{β}_{opt} + k ( x ) \vert {β}_{indiv} - {β}_{opt} \vert}{{β}_{opt}} \sqrt{\frac{Δ τ}{{τ}_{max}}} M & equation 39 \\ Δ M = \frac{25 + 0.947 \vert 27.3437 - 25 \vert}{25} \sqrt{\frac{1 / 356}{102}} 70 = 0.4000 kg per day & equation 40\end{matrix}$$

The individual's theoretical adult lifespan is then determined as follows:

$$\begin{matrix}{τ}_{theory\_adult} = {Δτ ( \frac{M}{Δ M} )}^{2} \\ = \frac{1 year}{365 days} {( \frac{70 kg}{0.40 kg per day} )}^{2} \\ = 84 years\end{matrix} \qquad equation 41$$

Using the set value of eighteen for the childhood lifespan (τ_{childhood}), a theoretical total lifespan (F) is determined:

Γ=τ_{theory}_{_{—}}_{adult}+τ_{childhood}=84 years+18 years=102 years equation 42

Actuarial tables are consulted and a suitable probability of survival (p_{A}) is chosen based on the individual person's demographic data. In the hypothetical example 1, p_{A} is 0.95 and the current age (A) is 40 years. An expected lifespan (F) is determined as follows:

F=p_{A}(Γ−A)=0.95(102 years−40 years)=59 years equation 43

By contrasting examples 1 and 4 it is apparent both individuals have similar expected lifespan (F) despite the calculation of example 4 not having access to the nutritional consumption rate of the individual.

### Example 5

### Nutritional Consumption Rate

A system for setting a life insurance premium is described for a 48 year-old person (A=48) with a mass of 70 kg (M=70 kg). This individual was determined to have a nutritional consumption rate of 0.405 kg of food per day (ΔM_{A}=0.405 kg per day). An idealized ΔM_{childhood} of 0.363 is calculated (120 years−18 years=102, M=70 kg). In this example, the mass of the individual at age 18 and at age 48 are both 70 kg.

$$\begin{matrix}{CF}_{A} = \frac{{τ}_{childhood} + Δ {τ ( \frac{{M}_{A}}{Δ {M}_{A}} )}^{2} - A}{Δ {τ ( \frac{{M}_{childhood}}{Δ {M}_{childhood}} )}^{2}} \\ = \frac{18 + \frac{1 year}{365 days} {( \frac{70 kg}{0.405 kg per day} )}^{2} - 48}{\frac{1 year}{365 days} {( \frac{70 kg}{0.363 kg per day} )}^{2}} \\ = 0.51\end{matrix} \qquad equation 44$$

Based on this CF_{A} value, a new premium rate can be determined. In the example, a current premium P_{Current} ($100) is multiplied by the compression factor CF_{A} and a function ƒ which, in the example is multiplying by a factor of 1.86.

P_{New}=ƒ(CF_{A})×P_{Current}=1.86(0.51)×$100=$95 equation 45

### Example 6

### Specific Heat

A life expectancy calculation is described for an individual with a specific heat Cᵥ^{specific} of 3456.5 J/kgK.

τ_{theory}_{_{adult}}=Δτ·3.515×1031(4.872×10⁻³⁸·3456.5)^{0.00048042(3456·5-1794)}=102 years Equation 46:

Advantageously, this permits the calculation of a predicted adult lifespan that is mass independent.

### Example 7

### Specific Heat

A life expectancy calculation is described for an individual with a specific heat Cᵥ^{Specific} of 3462.4 J/kgK.

τ_{theory}_{_{adult}}=Δτ·3.515×1031(4.872 λ10⁻³⁸·3462.4)^{0.00048042(3462.4-1794)}=82 years Equation 47:

Examples 6 and 7 clearly show a predicted lifespans that are different for two individuals with different specific heats and that these different lifespans are independent of the individual's mass.

### Example 8

### Specific Heat

A life expectancy calculation is described for an individual with a specific Heat Cᵥ^{Specfic} of 3470 J/kgK.

τ_{theory}_{_{adult}}=Δτ·3.515×1031(4.872×10⁻³⁸·3470)^{0.00048042(3470-1794)}=62 years Equation 48:

Examples 6 and 8 clearly show a predicted lifespans that are different for two individuals with different specific heats and that these different lifespans are independent of the individual's mass.

### Example 9

### Specific Heat

Equation 49:

A life expectancy calculation is described for an individual with a specific heat Cᵥ^{Specific} of 3480.5 J/kgK.

τ_{theory}_{_{adult}}=Δτ·3.515×1031(4.872×10⁻³⁸·3480.5)^{0.00048042(3480.5-1794)}=42 years

Examples 6 and 9 clearly show a predicted lifespans that are different for two individuals with different specific heats and that these different lifespans are independent of the individual's mass. Example 9 specifically illustrates a dramatic shorting of lifespan that can occur under strained metabolic conditions.

What is claimed is:

1. A computer-implemented method for adjusting a life insurance premium for an adult, the method comprising the steps of:
determining a metabolic stress measurement for a human individual;
inputting, into a computer, the metabolic stress measurement;
calculating, using the computer, a theoretical adult lifespan (τ_{theory}) using the metabolic stress measurement, wherein the theoretical adult lifespan is not directly related to a mass of the human individual;
adjusting, using the computer, a life insurance premium using the theoretical adult lifespan.

2. The method as recited in claim 1, wherein the metabolic stress measurement is a nutritional consumption rate (ΔM) of the human individual.

3. The method as recited in claim 2, wherein the nutritional consumption rate (ΔM) is measured in kg per day.

4. The method as recited in claim 1, wherein the metabolic stress measurement is a specific heat Cᵥ^{specific} of the human individual.

5. The method as recited in claim 4, wherein the theoretical adult lifespan (τ_{theory}) is calculated according to:
$${τ}_{theory} = Δ τ \cdot 3.515 \times {10}^{31} {( 4.872 \times {10}^{- 38} \cdot {C}_{v}^{specific} )}^{0.00048042 ( {c}_{v}^{specific} - 1794 )}$$
where Δτ is a conversion factor for converting to years.

6. The method as recited in claim 5, wherein two individuals with different specific heat Cᵥ^{specific} but the same mass produce two different theoretical adult lifespans.

7. The method as recited in claim 4, wherein the theoretical adult lifespan (τ_{theory}) is calculated using a mass-independent relationship.

8. A computer-implemented method for adjusting a life insurance premium for an adult, the method comprising the steps of:
determining a specific heat Cᵥ^{specific} for a human individual;
inputting, into a computer, the specific heat Cᵥ^{specific};
calculating, using the computer, a theoretical adult lifespan (τ^{theory}) according to:
$${τ}_{theory} = Δ τ \cdot 3.515 \times {10}^{31} {( 4.872 \times {10}^{- 38} \cdot {C}_{v}^{specific} )}^{0.00048042 ( {c}_{v}^{specific} - 1794 )}$$
where Δτ is a conversion factor for converting to years;
adjusting, using the computer, a life insurance premium using the theoretical adult lifespan (τ_{theory}).

9. The method as recited in claim 8, wherein Cᵥ is between 3450 J/kgK and 3500 J/kgK.

10. The method as recited in claim 8, wherein Cᵥ is determined by providing the adult with a mass of food and monitoring a resulting change in temperature in the adult.

11. A computer-implemented method for adjusting a life insurance premium for an adult, the method comprising the steps of:
determining a first specific heat Cᵥ^{specific} for a first human individual that has a first mass;
inputting, into a computer, the first specific heat Cᵥ^{specific} calculating, using the computer, a first theoretical adult lifespan (τ_{theory}) according to:
$${τ}_{theory} = Δ τ \cdot 3.515 \times {10}^{31} {( 4.872 \times {10}^{- 38} \cdot {C}_{v}^{specific} )}^{0.00048042 ( {c}_{v}^{specific} - 1794 )}$$
using the first specific heat, where Δτ is a conversion factor for converting to years;
determining a second specific heat Cᵥ^{specific} for a second human individual that has a second mass, wherein the first mass and the second mass are the same but the first specific heat and the second specific heat are different;
inputting, into a computer, the second specific heat Cᵥ^{specific};
calculating, using the computer, a second theoretical adult lifespan (τ_{theory}) according to:
$${τ}_{theory} = Δ τ \cdot 3.515 \times {10}^{31} {( 4.872 \times {10}^{- 38} \cdot {C}_{v}^{specific} )}^{0.00048042 ( {c}_{v}^{specific} - 1794 )}$$
using the second specific heat, wherein the first theoretical adult lifespan and the second theoretical adult lifespan are different due to the first specific heat and the second specific heat being different;
adjusting, using the computer, a first life insurance premium using the first theoretical adult lifespan (τ_{theory}); and
adjusting, using the computer, second first life insurance premium using the second theoretical adult lifespan (τ_{theory}).
